(19) United States
(12) Patent Application Publication
(10) Pub. No.: US 2015/0245211 A1
(43) Pub. Date: Aug. 27, 2015

(54) COYED system

(71) Applicants: Happy Raouf Reda Dawood, Cairo (EG); Sherif Ezzat Zarif Aziz, Cairo (EG)

(72) Inventors: Happy Raouf Reda Dawood, Cairo (EG); Sherif Ezzat Zarif Aziz, Cairo (EG)

(21) Appl. No.: 14/282,020

(22) Filed: May 20, 2014

Related U.S. Application Data
(60) Provisional application No. 61/943,750, filed on Feb. 24, 2014.

(51) Int. Cl. H04W 12/08; G06F 9/44; H04L 29/08

(52) U.S. Cl. CPC H04W 12/08; H04L 67/1097; G06F 8/30

(57) ABSTRACT

The invention is a whole communication project by which you can reach your data from any place you are in the world, with a very high speed as if you are on your computer but instead of retention it in the hard drive of your computer, it will be on the huge servers of the (COYED) system without using any computer or laptop but by a new developed tablet device will be create to this project containing just (Rams, Motherboard, laser keyboard, wireless mouse, web cam and speaker) to act exactly like any computer we are using it.

### FIELD AND BACKGROUND OF THE INVENTION

Our world depends totally on computers to do our work but to communicate with our data which is not on our computer, we have to use the internet . . . but in case of a huge package of files, we need a very high speed to download or upload the data which will cost us a lot of money & time . . . but what if we can access any bulk of data with a speed as if you access it from your hard drive of your computer? Google & Microsoft offer an option to let any user can share his data or communicate his personal computer but under certain conditions which are sharing data & connecting to the computer holding the data I want with internet connection.

To communicate to your computer data especially your work data u have to go to place in which your data is in . . . like your office for example so what about working from any place you are with a full access to all of your data as if you are at your office?.

For your personal data u have to go home to be connected with your personal computer or carrying your laptop but what if we just use a tablet to access your data?

The most variable things we own like money or Jewelry we use to keep it in safe place like safe or bank account and instead we use our credit card in which replace to carry real money.

To do new business u have to rent office, hire employees, buying devices like computers . . . etc and also u need to be communicate with your stuff so u connect all your computer with a server to be communicate with all your office data but when u need to communicate personally with anyone of your stuff u will use another communication devices like cell phones so what about saving money of renting a place for offices and will do your work from any place you are with the same efficiency as if you are working on the computer of your office? So any employee can do a lot of work in the same day by the same salary, in addition to that anyone can work from his home. this will be very effective to sick people, pregnant women's, cold countries . . . etc.

Any communication device use operating system like for an example computers used Microsoft or Mac or any cell phone use android or Lotus or windows.

### SUMMARY OF THE INVENTION

The invention is a project of new way in communication allows any new user to communicate on his data whether it is work data or his personal data from anywhere at any time.

To be a new user all what u have to do is to go to the company branch register your name & determine your password after that u will deliver your new device in which has new operating system called COYED (Connect On Your Data) which let u choose the program u want to be on your account like if u are an accountant u have to choose all program related to your filed also u can choose all your entertainment program for your personal life. Automatically u will be able to have your new email on this network and 1 tira free space to upload all your personal data with full protect on your account from hacking & virus.

After u have your new account u can use this account to upload your work data if u want or otherwise if u deliver your COYED device from your office u will be able to use your new account to upload your personal data if u want.

U will be connected wireless with the COYED network . . . u are not now using internet as a connection but u use private wireless network for this company in which gives u high connection speed and u will communicate with any other user in the planet. So u don't need any more flash memory. If you want to download any data from any other user on COYED network all what u have to do is to send this data on his dropbox.

If u wants to have personal communication u able to contact visually by cam & audio by talking to him instead of cell phones.

If u are travelling and your office need u to do your job u don't need any more to go to your office u are already communicate with your work data from anywhere at any time.

For companies it will be different package now anyone can have his own business with less money u don't now need to rent office all what u need to choose your stuff and buy our suitable package so u can be communicate with your stuff without meeting then personally because u are connected with them all the time anywhere anytime.

The developed device (COYED tablet) will be encrypted u can't use this tablet without COYED system & u can't use this device except on our network it will be prepared to this network only with cheap price to make anyone in the world be user on this global network so after few years u will not need to have PC or laptop or even cell phone anymore.

All users will not worry anymore from viruses cause all users will be protected on our strong firewall and all users will not worry anymore about any problems could happened on the system cause we will provide any user with the immediate technical Support by pressing special bottom in the COYED device which allow to communicate with technical Support by voice in case of COYED system is down.

With COYED device u can work at anywhere cause it provided with laser keyboard & mobile wireless mouse so u can use any surface to be your disk and u already communicate with wireless network so at anytime also.

COYED device in future will be replacement for money how?????? COYED users will be able to buy and sell anything without using money in which it will be replaced by digit units specified to COYED system by transfer units from account to another between users.

The profit from this project is huge. If u are personal user u will be pay every year for your personal account . . . . But u wants to increase your storage space so u will have to pay extra fees for every year.

### BRIEF DESCRIPTION OF DRAWING

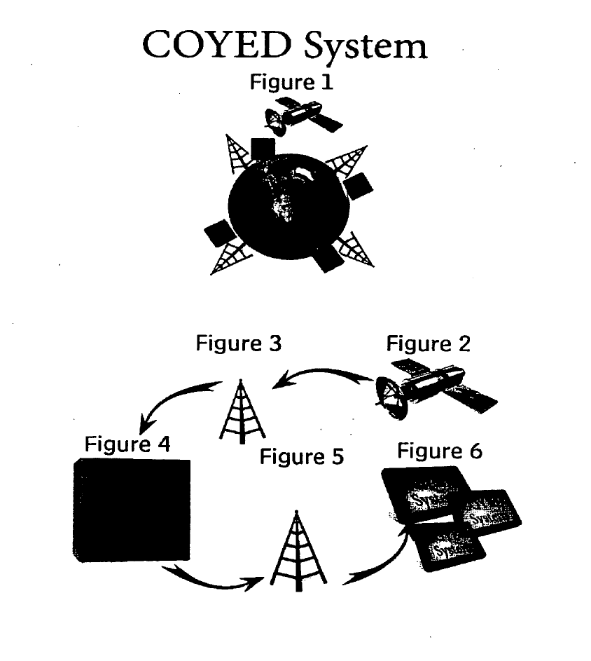

1. FIG. 1: represent the whole idea of COYED system around the globe.

2. FIG. 2: represent communication satellite for wireless COYED system network to connect each country network with each others around the globe.

3. FIG. 3: represent COYED wireless towers in each country as mobile wireless network to connect COYED devices & servers and satellite.

4. FIG. 4: represent the huge servers of each country to make users u load their data and make new account on COYED system.

5. FIG. 5: same COYED network as FIG. 3.

6. FIG. 6: represent COYED devices with COYED operating system.

1. Construct network like we used for mobile communication but this will be constructed only to make all devices connecting on the wireless network for COYED system with huge servers for retention the data of the customer.

2. (canceled)

3. New tablet device will be developed to act like computer we used in our daily life.

4. Create new operating system for COVED like (Microsoft, Mac, Lunix . . . etc) to be only used for this global network.
